(19) United States
(12) Patent Application Publication
(10) Pub. No.: US 2017/0017999 A1
(43) Pub. Date: Jan. 19, 2017

(54) INFORMATION PROCESSING DEVICE, INFORMATION PROCESSING METHOD, AND INFORMATION PROCESSING PROGRAM

(71) Applicant: RAKUTEN, INC, Tokyo (JP)

(72) Inventor: Isao TAKAHASHI, Setagaya-ku (JP)

(73) Assignee: Rakuten, Inc., Tokyo (JP)

(21) Appl. No.: 15/120,561

(22) PCT Filed: Feb. 28, 2014
(86) PCT No.: PCT/JP2014/055120

§ 371 Date: Aug. 22, 2016

(51) Int. Cl. G06Q 30/02

(52) U.S. Cl. CPC G06Q 30/0255; G06Q 30/0269

(57) ABSTRACT

Attribute information of a first object viewed or specified by a user and identification information of the user are obtained. Based on a combination of pieces of attribute information of objects identified from pieces of history information corresponding to the obtained identification information, an object combination corresponding to the obtained attribute information is determined. Information indicating the combination is presented to the user.

### TECHNICAL FIELD

The present invention relates to techniques for, for example, a system that recommends content to a user.

### BACKGROUND ART

A method for recommending content to a user based on the user's history information, such as his or her purchase history and viewing history, is conventionally known. For example, Patent Literature 1 discloses a method for more accurately recommending recommended content to a user, based not only on the user's purchase history but also on the user's history of handling files in an online storage.

### CITATION LIST

### Patent Literature

Patent Literature 1: JP 2004-13231 A

### SUMMARY OF INVENTION

### Technical Problem

However, just using a user's history information as in the conventional art sometimes cannot accurately recommend an object such as an item or a service that is currently desired by the user. In particular, when a combination of objects currently desired by a user needs to be recommended, it can be a problem that by using what type of grouping such an object combination is identified from the user's history information.

Therefore, in view of, for example, the above point, it is an object of the present invention to provide an information processing device, an information processing method, and an information processing program that are capable of accurately recommending a combination of objects currently desired by a user, based on the user's history information.

### Solution to Problem

To solve the above problem, the invention according to claim 1 includes first obtaining means, second obtaining means, first determining means, and presenting means. The first obtaining means obtains attribute information of a first object viewed or specified by a user and identification information of the user. Storage means stores history information including information about a second object previously viewed or specified by the user in association with identification information of a user. From the storage means, the second obtaining means retrieves the history information corresponding to the identification information obtained by the first obtaining means. Based on attribute information of the second object identified from the history information retrieved by the second obtaining means, the first determining means determines a second object combination that is a combination of the second objects corresponding to the attribute information obtained by the first obtaining means. The presenting means presents information indicating the second object combination determined by the first determining means to the user.

The invention according to claim 1 allows for accurate recommendation of a combination of objects currently desired by a user, based on the user's history information.

The invention according to claim 2 is the information processing device according to claim 1 in which based on priorities of a plurality of pieces of the attribute information, the first determining means determines the second object combination corresponding to a combination of pieces of attribute information whose priorities are relatively high.

The invention according to claim 2 allows for determination of a combination of objects that are of greater interest to the user.

The invention according to claim 3 is the information processing device according to claim 2 further including setting means. The setting means sets the priority higher for the attribute information having a larger number of pieces of history information, among a plurality of pieces of the attribute information.

The invention according to claim 3 allows for determination of a combination of objects that are of greater interest to the user.

The invention according to claim 4 is the information processing device according to claim 3 in which the setting means sets the priority higher for the attribute information having a larger number of the pieces of history information and having a shorter elapsed time since the pieces of history information were stored in the storage means.

The invention according to claim 4 allows for determination of a combination objects that are of greater recent interest to the user.

The invention according to claim 5 is the information processing device according to claim 2 further including setting means. The setting means sets the priority higher for the attribute information having a longer length of time used to view second objects indicated by pieces of history information thereof, among a plurality of pieces of the attribute information.

The invention according to claim 5 allows for determination of a combination of objects that were viewed for a long time and that are of greater interest to the user.

The invention according to claim 6 is the information processing device according to claim 5 in which the setting means sets the priority higher for the attribute information having a longer length of time used to view the second objects indicated by the pieces of history information and having a shorter elapsed time since the pieces of history information were stored in the storage means.

The invention according to claim 6 allows for determination of a combination objects that are of greater recent interest to the user.

The invention according to claim 7 is the information processing device according to any one of claims 1 to 6 in which the second obtaining means retrieves the history information in which a length of time used to view a second object indicated thereby is greater than or equal to a threshold value, from among a plurality of pieces of the history information.

The invention according to claim 7 allows for determination of a combination of objects that are of greater interest to the user.

The invention according to claim 8 is the information processing device according to any one of claims 1 to 7 in which the second obtaining means retrieves the history information except the history information already used to determine the second object combination.

The invention according to claim 8 makes it possible to avoid presenting the same object combination to the user more than once in a brief period of time as much as possible.

The invention according to claim 9 is the information processing device according to any one of claims 1 to 8 in which the first determining means determines the second object combination only when the number of pieces of history information of each of a plurality of pieces of the attribute information is greater than or equal to a first threshold value and the number of the pieces of attribute information, whose number of the pieces of history information is greater than or equal to a first threshold value, is greater than or equal to a second threshold value.

The invention according to claim 9 allows for improved accuracy of a combination of objects currently desired by the user.

The invention according to claim 10 is the information processing device according to any one of claims 1 to 8 in which the first determining means determines the second object combination only when a length of time used to view second objects indicated by pieces of history information of each of a plurality of pieces of the attribute information is greater than or equal to a first threshold value and the number of the pieces of attribute information, which each have a viewing length of time greater than or equal to a first threshold value, is greater than or equal to a second threshold value.

The invention according to claim 10 allows for improved accuracy of a combination of objects currently desired by the user.

The invention according to claim 11 is the information processing device according to any one of claims 1 to 8 in which the first determining means determines the second object combination only when a priority of the attribute information is greater than or equal to a third threshold value.

The invention according to claim 11 allows for improved accuracy of a combination of objects currently desired by the user.

The invention according to claim 12 is the information processing device according to any one of claims 1 to 11 further including third obtaining means and second determining means. From storage means for storing the history information in association with identification information of a user, the third obtaining means retrieves the history information corresponding to a predetermined user identification information. Based on attribute information of the second object identified from the history information retrieved by the third obtaining means, the second determining means determines an incomplete combination of pieces of attribute information. The incomplete combination lacks one or more pieces of attribute information. The storage means stores incomplete information about the incomplete combination determined by the second determining means in association with the user identification information. From the storage means, the second obtaining means retrieves the incomplete information corresponding to the identification information obtained by the first obtaining means. The first determining means determines the second object combination, based on the attribute information obtained by the first obtaining means and on the incomplete information retrieved by the second obtaining means.

Even if no theme combination is completed depending on what a user's history information includes, the invention according to claim 12 allows for a reduction in the load required for an information providing device to determine a combination when the user views or specifies an object and for more quick recommendation of a combination of objects currently desired by the user.

The invention according to claim 13 is the information processing device according to any one of claims 1 to 12 in which if, within a predetermined period of time after the second object combination corresponding to the first attribute information is determined, the second attribute information identical to the first attribute information is obtained, the determining means does not determine the second object combination corresponding to the second attribute information.

The invention according to claim 13 makes it possible to avoid the complexity of presenting the same object combinations to the user in a brief period of time.

The invention according to claim 14 is an information processing method performed by a computer. The method includes the following steps. Attribute information of a first object viewed or specified by a user and identification information of the user are obtained. From storage means for storing history information including information about a second object previously viewed or specified by the user in association with identification information of the user, the history information corresponding to the obtained identification information is retrieved. Based on attribute information of the second object identified from the retrieved history information, a second object combination is determined.

The second object combination is a combination of the second objects corresponding to the obtained attribute information. Information indicating the determined second object combination is presented to the user.

The invention according to claim 15 causes a computer to function as first obtaining means, second obtaining means, determining means, and presenting means. The first obtaining means obtains attribute information of a first object viewed or specified by a user and identification information of the user. From storage means for storing history information including information about a second object previously viewed or specified by the user in association with identification information of the user, the second obtaining means retrieves the history information corresponding to the identification information obtained by the first obtaining means. Based on attribute information of the second object identified from the history information retrieved by the second obtaining means, the determining means determines a second object combination that is a combination of the second objects corresponding to the attribute information obtained by the first obtaining means. The presenting means presents information indicating the second object combination determined by the determining means to the user.

### Advantageous Effects of Invention

This invention allows for accurate recommendation of a combination of objects currently desired by a user, based on the user's history information.

### BRIEF DESCRIPTION OF DRAWINGS

FIG. 1 is a diagram schematically showing an example configuration of an information providing system S according to this embodiment.

FIG. 2A is a diagram showing an example of an association list that stores objects and themes in association with each other.

FIG. 2B is a diagram showing an example of a theme combination list that stores a plurality of combinations of the themes shown in FIG. 2A.

FIG. 3A is a block diagram schematically showing an example configuration of an information providing server SA according to this embodiment.

FIG. 3B is a diagram showing example functional blocks in a system controller 4.

FIG. 4 is a diagram showing an example of viewing histories stored in a history information database 22.

FIG. 5 is a flowchart showing a combination presentation process performed by the system controller 4 of the information providing server SA, in Example 1.

FIG. 6 is a diagram showing an example display screen of information indicating an object combination.

FIG. 7A is a flowchart showing a combination predetermination process performed by the system controller 4 of the information providing server SA, in Example 2.

FIG. 7B is a flowchart showing a combination presentation process performed by the system controller 4 of the information providing server SA, in Example 2.

FIG. 8A is a diagram showing an example of an object combination list.

FIG. 8B is a diagram showing an example of incomplete theme combinations.

FIG. 8C is a diagram showing an example of an incomplete combination list.

FIG. 9A is a flowchart showing an incomplete combination predetermination process performed by the system controller 4 of the information providing server SA, in Example 3.

FIG. 9B is a flowchart showing a combination presentation process performed by the system controller 4 of the information providing server SA, in Example 3.

### DESCRIPTION OF EMBODIMENTS

The following describes an embodiment of the present invention with reference to the drawings. In the embodiment described below, the present invention is applied to an information providing system.

### 1. Configuration and Functional Overview of Information Providing System

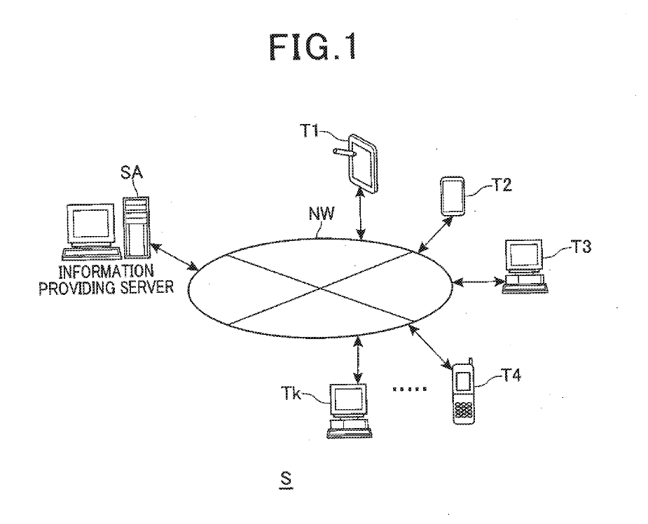

First, a configuration and a functional overview of an information providing system S according to an embodiment of the present invention will be described with reference to FIG. 1.

FIG. 1 is a diagram schematically showing an example configuration of the information providing system S according to this embodiment. As shown in FIG. 1, the information providing system S includes a plurality of user terminals Tn (n=1, 2 . . . k) and an information providing server SA. The information providing server SA is an example of an information processing device according to the present invention. Each user terminal Tn and the information providing server SA are connected to a network NW and capable of exchanging data with each other over the network NW using communication protocols, such as TCP/IP. The network NW includes, for example, the Internet, a dedicated communication line (e.g., community antenna television (CATV) line), a mobile communication network (including base stations), and a gateway.

The user terminal Tn may be, for example, a personal computer (PC), a mobile phone, a personal digital assistant (PDA), a mobile terminal (smartphone) that is a mobile phone integrated with a personal digital assistant, a tablet, or a terminal device such as a handheld game console. The user terminal Tn sends a page request (hypertext transfer protocol (HTTP) request) to the information providing server SA through a web browser to retrieve a web page, and displays the web page in a window screen appearing on its display.

The information providing server SA includes one or more server computers that have the functions of, for example, a web server, an application server, and a database server. The information providing server SA constitutes an information providing site (website) that provides, for example, information about tourist sites, facilities, and items. This information providing site may be included in an information retrieval site, a blog site, an SNS site, an item sales site (shopping site), a travel reservation site, a lodging reservation site, a facility reservation site, or the like, or alternatively may be operated in cooperation with these sites (e.g., by the same operator). Examples of the facilities include lodging facilities (e.g., hotels), tourist facilities, golf course facilities, tennis court facilities, amusement facilities, public facilities, and commercial facilities (including stores).

Web pages provided to the user terminals Tn, for example, by the information providing site include structured document data, such as hypertext markup language (HTML) documents and XHTML documents, image data, and other data. In some cases, attribute information of an object indicated by a web page is written in information identifying the web page (e.g., the uniform resource locator (URL) of the web page). In other cases, attribute information of an object (first object) indicated by a web page is embedded in the web page (written in an HTML document) as a tag. This tag is usually attached to classify and search for information treated in the web page. The object is, for example, a thing that users can view or specify. Examples of the thing include a tourist site, facilities, and an item. Such an object (first object) can also appear, as a word, a phrase, or the like, in a search query that a user specifies (enters or selects) in a search term entry field displayed in a window screen, for example, by a web browser or various application software. In this case, attribute information of the object appearing in the search query is specified, for example, based on an association list that stores objects and themes in accordance with each other or on an association list that stores objects and places in accordance with each other. In this embodiment, a place available for obtaining or using (including eating and drinking) an object and a theme (subject) that the object has is taken as an example of attribute information of the object. Examples of the place available for obtaining or using the object are each classified, for example, by country, prefecture, city, town, or village.

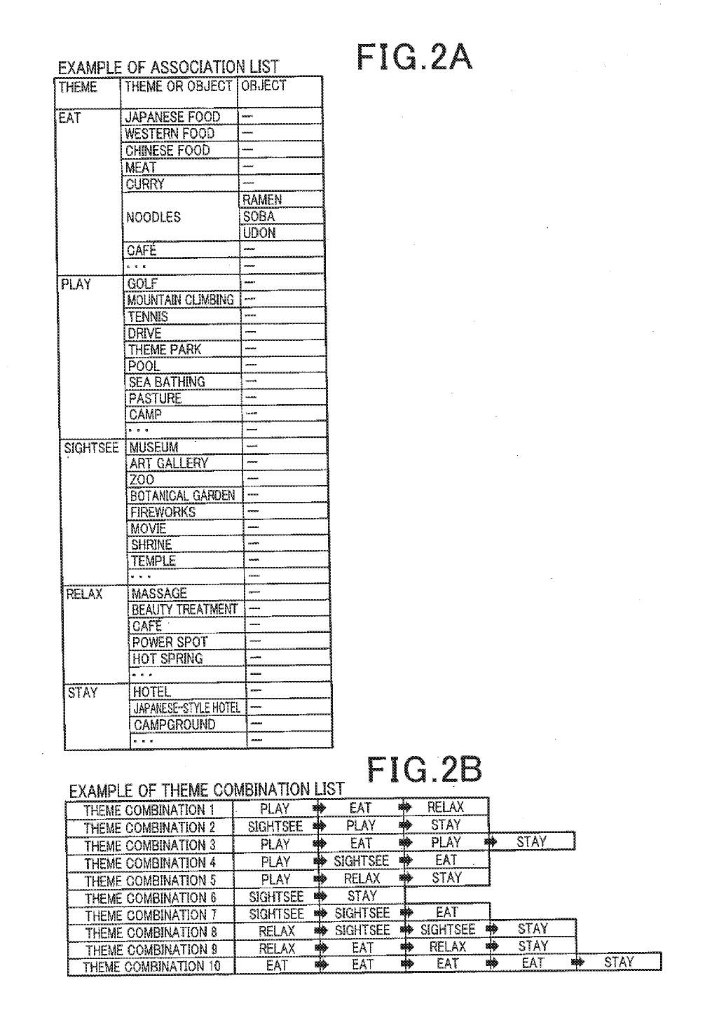

FIG. 2A is a diagram showing an example of the association list that stores objects and themes in association with each other. In the example of FIG. 2, the themes “eat”, “play”, “sightsee (watch)”, “relax”, and “stay” are shown. For example, “eat” is associated with the objects “Japanese food”, “Western food”, “Chinese food”, “meat”, “curry”, “noodles”, and “café”. That is, “eat” corresponds to the theme “Japanese food” and the like. “Noodles” are associated with “ramen”, “soba”, and “udon”. That is, “eat” and “noodles” correspond to the theme “ramen” and the like. In this manner, themes and objects are in the relationship between superordinate concepts and subordinate concepts. For example, assuming that an object (object name) specified by a user is “Shinshu noodles”, “eat” is identified as attribute information of “Shinshu noodles” from the association list shown in FIG. 2A. Assuming that the object is “Shinshu noodles”, “Nagano” is identified as attribute information of “Shinshu noodles” from an association list (not shown) that stores objects and places in association with each other. Attribute information of an object may be identified, for example, in the order from a “theme” to a “place”. In this case, an object (e.g., a word) used to identify a “theme” may not be used to identify any “place”. For example, when the theme “eat” is identified from the object “Kitakata ramen”, “the place “Kitakata” is not identified from “Kitakata ramen” even if the association list stores the object “Kitakata ramen” and the place “Kitakata” in association with each other. The reason is that the word “Kitakata ramen”, for example, is given by joining a place name and a food name into one food name and that the place name “Kitakata” included in this food name is now likely to be used not only in the place. This allows a more appropriate object combination to be determined. Alternatively, when attribute information of an object is identified, if the number of “places” associated with the object (e.g., Kitakata ramen) to be identified is greater than or equal to a predetermined number (e.g., two), the object may not be used to identify any “place”. This is because stores that provide Kitakata ramen, for example, can be located not only in Fukushima but also in Tokyo and other prefectures. This also allows an appropriate object combination to be determined. As a “place” corresponding to a word, data prestored in various databases may be used.

FIG. 2B is a diagram showing an example of a theme combination list that stores a plurality of combinations of the themes shown in FIG. 2A. The theme combination list shown in FIG. 2B stores ten theme combinations (complete combinations). As shown in FIG. 2B, the themes that constitute each theme combination vary in number. For example, the number of themes that constitute the theme combination 1 is three, and “play”, “eat”, and “relax” are registered in three fields. The arrow shown in FIG. 2B indicates in what order to use themes. Each theme combination is determined, for example, by an operator of the information providing site.

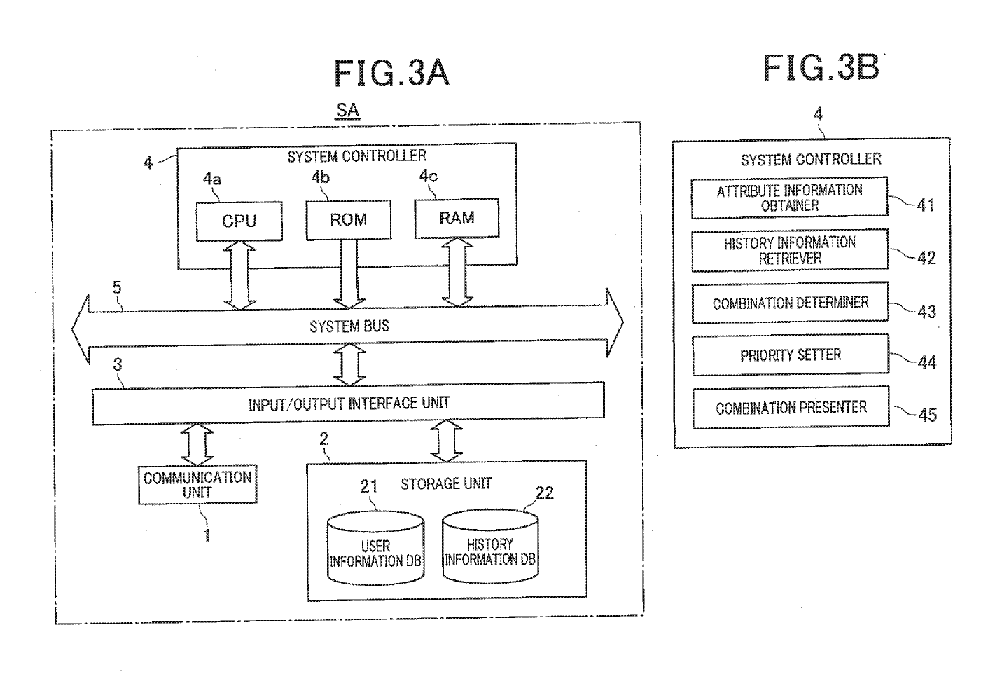

FIG. 3A is a block diagram schematically showing an example configuration of the information providing server SA according to this embodiment. As shown in FIG. 3A, the information providing server SA includes a communication unit 1, a storage unit 2, an input/output interface unit 3, and a system controller 4. The system controller 4 and the input/output interface unit 3 are connected via a system bus 5. The input/output interface unit 3 performs interface processing between the communication unit 1 and the storage unit 2, and the system controller 4. The storage unit 2 is an example of storage means of the present invention. The storage unit 2 may be included in another server accessible from the information providing server SA. The communication unit 1 connects to the network NW and controls the state of communications with, for example, the user terminals Tn.

The storage unit 2 includes, for example, hard disk drives. The storage unit 2 stores various programs, such as an operating system and server programs (including an information processing program according to the present invention). For example, the server programs may be delivered from a predetermined server or the like over the network NW, or may be provided via a (computer-readable) recording medium, such as a compact disc (CD) or a digital versatile disc (DVD), storing the programs. The storage unit 2 also stores structured document data, image data, and other data that constitute web pages to be displayed on the user terminals Tn. The storage unit 2 also stores the above-described association lists and the theme combination list. The storage unit 2 further has a user information database (DB) 21, a history information database (DB) 22, and other databases that are created therein.

The user information database 21 stores, in association with each user who has signed up as a member, the user's user ID, login ID, password, nickname, name, gender, age, address, telephone number, e-mail address, and other information, which have been registered. Each user's user ID is identification information unique to the user. The login ID and the password are authentication information used in a login process (process for authenticating the user). All or some of the user ID, the login ID, the password, the nickname, the name, the gender, the age, the address, the telephone number, and the e-mail address are input from the user terminal Tn and sent to the information providing server SA, for example, when the user signs up as a member.

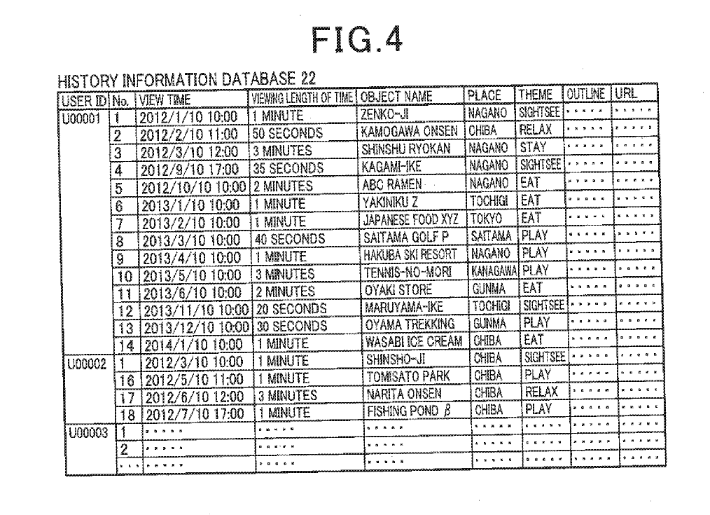

The history information database 22 stores, in association with each user, the user's user ID and the user's history information including, for example, information about an object (second object) previously viewed or specified by the user on a web page provided by the information providing site. Examples of the history information include a search history, a viewing history, a bookmarking history, and a purchase history. The search history includes, for example, information about an object specified by the user and the time when the user searched for the object. The viewing history includes, for example, information about an object viewed by the user, the time when the user viewed the object, and the length of time for which the user viewed the object. The bookmarking history includes, for example, information about an object bookmarked by the user and the time when the user bookmarked the object. The purchase history includes, for example, information about an object purchased by the user and the time when the user purchased the object. Examples of information about an object includes the name of the object (e.g., a tourist site name, a facility name, and an item name), an object ID identifying the object (e.g., a tourist site ID, a facility ID, and an item ID), a place available for using or obtaining the object (an address or latitude/longitude coordinates), a theme that the object has, an outline of the object, and the URL of a web page that provides detailed information about the object. The length of time used to view the object is the time from when the web page containing information about the object was displayed to when the web page was cleared (closed or turned). The viewing length of time is measured, for example, by the web browser of the user terminal Tn and is sent to the information providing server SA. The place available for using or obtaining the object and the theme that the object has may not be included in the history information, and may be retrievable using the object name or the object ID as a key. FIG. 4 is a diagram showing an example of viewing histories stored in the history information database 22. In the example of FIG. 4, the viewing history of the user assigned the user ID “U00001” stores fourteen records.

The system controller 4 includes, for example, a central processing unit (CPU) 4a, a read only memory (ROM) 4b, and a random access memory (RAM) 4c. FIG. 3B is a diagram showing example functional blocks in the system controller 4. The system controller 4 as a computer performs a process for determining and presenting an object combination (hereinafter, referred to as a “combination presentation process”), in accordance with the server programs stored in the storage unit 2. In this process, as shown in FIG. 3B, the system controller 4 functions as, for example, an attribute information obtainer 41, a history information retriever 42, a combination determiner 43, a priority setter 44, and a combination presenter 45. The attribute information obtainer 41 is an example of first obtaining means of the present invention. The history information retriever 42 is an example of second obtaining means and third obtaining means of the present invention. The combination determiner 43 is an example of first determining means and second determining means of the present invention. The priority setter 44 is an example of setting means of the present invention. The combination presenter 45 is an example of presenting means of the present invention.

The attribute information obtainer 41 obtains a user's user ID and attribute information of an object viewed or specified by the user. The history information retriever 42 retrieves, from the history information database 22, the pieces of history information corresponding to the user ID obtained by the attribute information obtainer 41 (i.e., the pieces of history information associated with the user ID).

The combination determiner 43 determines an “object combination” corresponding to the attribute information (e.g., at least one of a place and a theme) obtained by the attribute information obtainer 41, based on pieces of attribute information of objects identified from the pieces of history information retrieved by the history information retriever 42. For example, the combination determiner 43 determines an “object combination” corresponding to a “theme combination” that corresponds to the place obtained by the attribute information obtainer 41 (i.e., available in the place) and that is included in the pieces of history information retrieved by the history information retriever 42. Alternatively, the combination determiner 43 determines an “object combination” corresponding to a “theme combination” that includes the theme obtained by the attribute information obtainer 41 (i.e., that corresponds to the theme) and that is included in the pieces of history information retrieved by the history information retriever 42. Alternatively, the combination determiner 43 determines an “object combination” corresponding to a “theme combination” that corresponds to the place obtained by the attribute information obtainer 41, that includes the theme obtained by the attribute information obtainer 41, and that is included in the pieces of history information retrieved by the history information retriever 42.

Based on priorities of a plurality of pieces of the above attribute information, the combination determiner 43 may determine an “attribute information combination” whose priorities are relatively high. The priorities of the pieces of attribute information are set by the priority setter 44.

The combination presenter 45 presents information indicating the “object combination” determined by the combination determiner 43 to the user corresponding to the user ID obtained by the attribute information obtainer 41. For example, the combination presenter 45 sends information indicating the object combination to the user terminal Tn of the user to present the information.

### 2. How Information Providing System S Works

The following describes how the information providing system S works in separate Examples 1 to 3. The following description assumes that the information providing server SA identifies the user ID of a user of the user terminal T1 by performing a login process in response to a login request from the user terminal T1.

### Example 1

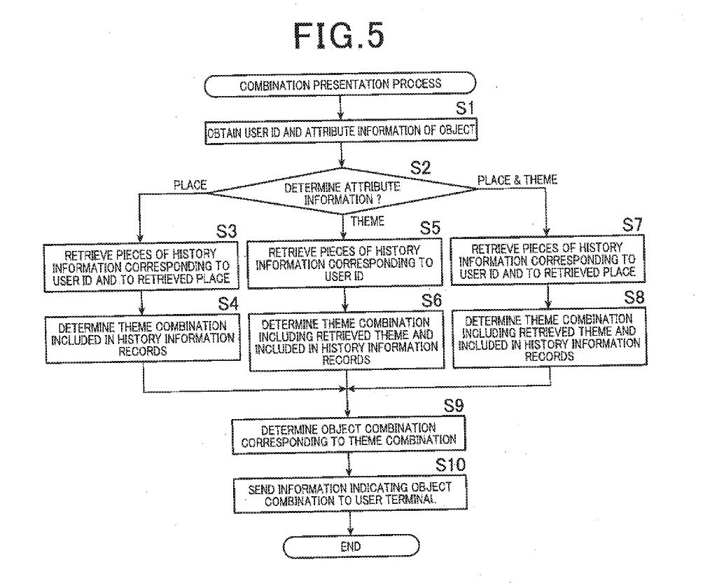

The following first describes how the information providing system S according to Example 1 works, with reference to FIG. 5. FIG. 5 is a flowchart showing a combination presentation process performed by the system controller 4 of the information providing server SA, in Example 1. When receiving, from the user terminal T1, a search request including a search query that the user specified in a search term entry field displayed, for example, by the web browser of the user terminal T1, the system controller 4 of the information providing server SA starts the combination presentation process shown in FIG. 5. Alternatively, when receiving, from the user terminal T1, a web page request specified by the user of the user terminal T1 via the web browser, the system controller 4 of the information providing server SA starts the combination presentation process shown in FIG. 5.

When the combination presentation process shown in FIG. 5 is started, the attribute information obtainer 41 of the system controller 4 obtains the user ID of the user of the user terminal T1, which has sent the search request or the page request, and attribute information of an object viewed or specified by the user (Step S1). For example, the attribute information obtainer 41 identifies an object from the received search query, based on the above-described association lists, and identifies and obtains attribute information of the identified object from the association lists. Alternatively, the attribute information obtainer 41 identifies and obtains attribute information of an object indicated by the web page relating to the received page request, for example, from a tag or the URL of the web page. In Step S1, there may be a case where two or more pieces of attribute information, such as “Nagano” (place) and “stay” (theme), are identified and obtained. In this case, for example, if the attribute information obtainer 41 of the system controller 4 can identify a “theme” (e.g., eat) from the above identified object (e.g., Kitakata ramen), no “place” may be identified from the identified object. If the number of “places” associated with the above identified object (e.g., Kitakata ramen) is greater than or equal to the predetermined number, no “place” may be identified from the identified object. There may also be a case where two or more pieces of attribute information, such as “stay” (theme) and “eat” (theme), are obtained. The attribute information obtainer 41 of the system controller 4 terminates the combination presentation process shown in FIG. 5, if it cannot obtain any attribute information of the object viewed or specified by the user.

If an “object combination” corresponding to first attribute information of the object viewed or specified by the user (e.g., an “object combination” corresponding to a “theme combination” that includes a first theme of the object viewed or specified by the user) is determined in the previously performed combination presentation process and second attribute information identical to the first attribute information is obtained in Step S1 within a predetermined period of time (e.g., 24 hours) after the determination, the system controller 4 may terminate the process without performing Step S2 and subsequent steps (i.e., without determining any “object combination” corresponding to the second attribute information). This makes it possible to avoid the complexity of presenting the same “object combinations” to the user in a brief period of time.

Subsequently, the system controller 4 determines whether the attribute information obtained in Step S1 is a place, a theme, or both a place and a theme (Step S2). If it is determined that the attribute information is a place (i.e., only a place is obtained as the attribute information) (PLACE in Step S2), the process proceeds to Step S3. On the other hand, if it is determined that the attribute information is a theme (i.e., only a theme is obtained as the attribute information) (THEME in Step S2), the process proceeds to Step S5. On the other hand, if it is determined that the attribute information is both a place and a theme (i.e., a place and a theme are obtained as the attribute information) (PLACE & THEME in Step S2), the process proceeds to Step S7.

In Step S3, the history information retriever 42 of the system controller 4 retrieves, from the history information database 22, the pieces of history information corresponding to the user ID obtained in Step S1 and to the place retrieved in Step S1 (the pieces of history information including the place). For example, when the user ID is “U00001” and the place is “Nagano”, the history information records with the record Nos. 1, 3, 4, 5, and 9, which are associated with “U00001”, are retrieved from the history information database 22 shown in FIG. 4.

In Step S3, the history information retriever 42 of the system controller 4 may retrieve, among the plurality of history information records, a history information record in which the length of time used to view the object indicated by the record is greater than or equal to a threshold value (e.g., one minute or more). Consequently, for example, when the user ID is “U00001” and the place is “Nagano”, only the history information records with the record Nos. 1, 3, 5, and 9, which are associated with “U00001”, are retrieved from the history information database 22 shown in FIG. 4. This allows for determination of an “object combination” that was viewed for a long time and that is of greater interest to the user. Alternatively, the history information retriever 42 of the system controller 4 may retrieve a history information record except the history information records already used to determine an object combination. This makes it possible to avoid presenting the same “object combination” to the user more than once in a brief period of time as much as possible.

Subsequently, the combination determiner 43 of the system controller 4 determines a “theme combination” that is included in the history information records retrieved in Step S3, for example, by referring to the above-described theme combination list (Step S4), and then the process proceeds to Step S9. That is, a “theme combination” made up of a plurality of themes included in the history information is determined. For example, when the history information records with the record Nos. 1, 3, 4, 5, and 9, which are associated with “U00001”, are retrieved from the history information database 22 shown in FIG. 4, the theme combinations 2, 4, 6, and 7 are determined from the theme combination list shown in FIG. 2B. That is, the combinations 2, 4, 6, and 7, which are completed by filling all the fields with theme (s) included in the history information records with the record Nos. 1, 3, 4, 5, and 9 associated with “U00001”, are determined. For example, the theme combination 1 becomes an incomplete theme combination because it lacks one “relax” (the “relax” field is not filled), and thus is not determined in Step S4. Also for example, the theme combination 9 becomes an incomplete “theme combination” because it lacks two “relax”, and thus is not determined in Step S4.

In Step S4, based on the priorities of the themes included in the history information records corresponding to the user ID obtained in Step S1 or the history information records retrieved in Step S3, the combination determiner 43 of the system controller 4 may determine a “theme combination” whose priorities are relatively high. In this case, for example, the priority setter 44 of the system controller 4 assigns a higher priority to a theme that has a larger number of history information records, among the plurality of themes. For example, in all the history information records corresponding to the user ID “U00001” obtained in Step S1, the number of records of “play” (i.e., the number of history information records including “play”) is “four”, the numbers of records of “sightsee” and “eat” are each “three”, and the numbers of records of “relax” and “stay” are each “one”. Thus, based on these numbers of records, for example, the priority setter 44 sets the priority of “play” to “four”, sets each of the priorities of “sightsee” and “eat” to “three”, and sets each of the priorities of “relax” and “stay” to “one”. Based on the priorities thus assigned to the themes, the combination determiner 43 determines, for example, at least one of the following combinations: the combination of “play”, “sightsee”, and “eat” that have relatively high priorities (the theme combination 4 shown in FIG. 2B); and the combination of “sightsee” and “eat” that have relatively high priorities (the theme combination 7 shown in FIG. 2B). This allows for determination of an “object combination” that is of greater interest to the user.

Alternatively, the priority setter 44 may assign a higher priority to a theme that has a larger number of history information records and that has a shorter elapsed time since the pieces of history information corresponding to the theme were stored in the history information database 22 (i.e., a more recently registered theme), among the plurality of themes. The elapsed time is calculated to be, for example, the difference between the view time and the current time. Based on the priorities thus assigned to the themes, the combination determiner 43 determines a combination of themes whose priorities are relatively high (i.e., themes each having a larger number of records and a shorter elapsed time). This allows for determination of an “object combination” that is of greater recent interest to the user. Alternatively, the priority setter 44 may assign a higher priority to a theme that has a longer length of time used to view the objects indicated by its pieces of history information, among the plurality of themes. Based on the priorities thus assigned to the themes, the combination determiner 43 determines a combination of themes whose priorities are relatively high (i.e., themes each having a longer viewing length of time). This allows for determination of an “object combination” that is of greater interest to the user. Alternatively, the priority setter 44 may assign a higher priority to a theme that has a longer length of time used to view the objects indicated by its pieces of history information and that has a shorter elapsed time since its pieces of history information were stored in the history information database 22, among the plurality of themes. Based on the priorities thus assigned to the themes, the combination determiner 43 determines a combination of themes whose priorities are relatively high (i.e., themes each having a longer viewing length of time and a shorter elapsed time). This allows for determination of an “object combination” that is of greater recent interest to the user.

On the other hand, in Step S5, the history information retriever 42 of the system controller 4 retrieves, from the history information database 22, the pieces of history information corresponding to the user ID obtained in Step S1. In this case, as in Step S3, among the plurality of pieces of history information, history information in which the length of time used to view the object indicated by its record is greater than or equal to the threshold value may be retrieved, or history information except the history information records already used to determine an object combination may be retrieved.

Subsequently, the combination determiner 43 of the system controller 4 determines a “theme combination” that includes the theme retrieved in Step S1 and that is included in the history information records retrieved in Step S5, for example, by referring to the above-described theme combination list (Step S6), and then the process proceeds to Step S9. For example, when the theme retrieved in Step S1 is “relax” and the history information records with the record Nos. 1 to 14, which are associated with “U00001”, are retrieved from the history information database 22 shown in FIG. 4, the theme combinations 1, 5, and 8 are determined from the theme combination list shown in FIG. 2B. In all the history information records with record No. 1 to 14 associated with “U00001”, the number of records of “relax” is “one”. Thus, for example, the theme combination 9 lacks another “relax”. Consequently, the theme combination 9 becomes an incomplete “theme combination”, and thus is not determined in Step S6. If the number of themes retrieved in Step S1 is greater than or equal to two, a “theme combination” that includes all the themes may be determined, or a “theme combination” that includes some of the themes may be determined.

Alternatively, in Step S6, the combination determiner 43 of the system controller 4 may also determine a “theme combination” that is made up of the theme retrieved in Step S1 and theme (s) included in the history information records retrieved in Step S5, for example, by referring to the above-described theme combination list. That is, in this case, the theme retrieved in Step S1 is handled as history information. For example, in all the history information records with record Nos. 1 to 14 associated with “U00001”, the number of records of “relax” is “one”. However, if the theme retrieved in Step S1 is “relax”, the number of records of “relax” becomes “two”. Consequently, the theme combination 9 becomes a complete “theme combination”, and thus is determined in Step S6. That is, in this case, the theme combinations 1, 5, 8, and 9 are determined from the theme combination list shown in FIG. 2B.

In Step S6, based on the priorities of the themes included in the plurality of history information records retrieved in Step S5, the combination determiner 43 of the system controller 4 may determine a “theme combination” whose priorities are relatively high. The method for setting the priorities of the themes and the method for determining a “theme combination” based on the set priorities are the same as Step S4. Based on the priorities of the places included in the plurality of history information records retrieved in Step S5, the combination determiner 43 may determine a “theme combination” associated with a place whose priority is relatively high. In this case, for example, the priority setter 44 of the system controller 4 assigns a higher priority to a place that has a larger number of history information records, among the plurality of places. For example, in all the history information records retrieved in Step S5, the number of records of “Nagano” is “five”, the numbers of records of “Chiba”, “Gunma”, and “Tochigi” are each “two”, and the numbers of records of “Tokyo”, “Saitama”, and “Kanagawa” are each “one”. Thus, based on these numbers of records, the priority setter 44 sets the priority of “Nagano” to “five”, sets each of the priorities of “Chiba”, “Gunma”, and “Tochigi” to “two”, and sets each of the priorities of “Tokyo”, “Saitama”, and “Kanagawa” to “one”. Based on the priorities thus assigned to the places, the combination determiner 43 determines, for example, a “theme combination” associated with “Nagano” that has a relatively high priority.

Alternatively, the priority setter 44 may assign a higher priority to a place that has a larger number of history information records and that has a shorter elapsed time since the pieces of history information corresponding to the place were stored in the history information database 22 (i.e., a more recently registered place), among the plurality of places. Alternatively, the priority setter 44 may assign a higher priority to a place that has a longer length of time used to view the objects indicated by its pieces of history information, among the plurality of places. Alternatively, the priority setter 44 may assign a higher priority to a place that has a longer length of time used to view the objects indicated by its pieces of history information and that has a shorter elapsed time since the pieces of history information were stored in the history information database 22, among the plurality of places. Based on the priority obtained by adding the priority of the place and the priority of the place included in each of the plurality of history information records retrieved in Step S5, the combination determiner 43 of the system controller 4 may determine a “theme combination” whose priorities are relatively high.

On the other hand, in Step S7, the history information retriever 42 of the system controller 4 retrieves, from the history information database 22, the pieces of history information corresponding to the user ID obtained in Step S1 and to the place retrieved in Step S1. In this case, as in Step S3, among the plurality of pieces of history information, history information in which the length of time used to view the object indicated by its record is greater than or equal to the threshold value may be retrieved, or history information except the history information records already used to determine an object combination may be retrieved.

Subsequently, the combination determiner 43 of the system controller 4 determines a “theme combination” that includes the theme retrieved in Step S1 and that is included in the history information records retrieved in Step S7, for example, by referring to the above-described theme combination list (Step S8), and then the process proceeds to Step S9. Alternatively, the combination determiner 43 of the system controller 4 may also determine a “theme combination” that is made up of the theme retrieved in Step S1 and theme(s) included in the history information records retrieved in Step S7, for example, by referring to the above-described theme combination list.

In Step S8, as in Step S4 or S6, based on the priority of at least one of the place and the theme included in each of the plurality of history information records, the combination determiner 43 of the system controller 4 may determine a “theme combination” whose priorities are relatively high. The method for setting the priorities in this case and the method for determining a “theme combination” based on the set priorities are the same as Step S4 or S6.

In Step S9, the combination determiner 43 of the system controller 4 determines an “object combination” corresponding to the “theme combination” determined in Step S4, S6, or S8, from the pieces of history information retrieved as described above. For example, assume that the theme combinations 2 and 7 are determined. In this case, the object combination (the combination of “Zenko-ji”, “Hakuba Ski Resort”, and “Shinshu Ryokan”) indicated by the pieces of history information with record Nos. 1, 9, and 3 associated with “U00001” and the object combination (the combination of “Kagami-ike”, “Hakuba Ski Resort”, and “Shinshu Ryokan”) indicated by the pieces of history information with record Nos. 4, 9, and 3 associated with “U00001” are each determined to be an “object combination” corresponding to the theme combination 2. Also, the “object combination” (the combination of “Zenko-ji”, “Kagami-ike”, and “ABC Ramen”) indicated by the pieces of history information with record Nos. 1, 4, and 5 associated with “U00001” is determined to be an “object combination” corresponding to the theme combination 7. Information indicating the “object combinations” thus determined can be provided to the user, for example, as itinerary information. It is preferable that the combination determiner 43 determine an “object combination” corresponding to the “theme combination” determined in Step S6 so that all of the places associated with the objects in the object combination are the same. For example, the places associated with “Zenko-ji” (theme: sightsee, place: Nagano), “Kagami-ike” (theme: sightsee, place: Nagano), and “ABC Ramen” (theme: eat, place: Nagano) are all “Nagano”, and thus are determined to be an object combination. On the other hand, not all of the places associated with “Zenko-ji” (theme: sightsee, place: Nagano), “Maruyama-ike” (theme: sightsee, place: Tochigi), and “ABC Ramen” (theme: eat, place: Nagano) are the same, and thus are not determined to be an object combination.

The combination determiner 43 of the system controller 4 may determine an object combination only when the number of pieces of history information of each of the plurality of themes is greater than or equal to a first threshold value (e.g., two) and the number of such themes, whose number of the pieces of history information is greater than or equal to the first threshold value, is greater than or equal to a second threshold value (at least two for determining a combination). Alternatively, the combination determiner 43 may determine an object combination only when the length of time used to view the objects indicated by the pieces of history information of each of the plurality of themes is greater than or equal to a first threshold value (e.g., one minute) and the number of such themes, which each have a viewing length of time greater than or equal to the first threshold value, is greater than or equal to a second threshold value (at least two for determining a combination). Alternatively, the combination determiner 43 may determine an object combination only when the priority of the place or the theme obtained in Step S1 is greater than or equal to a third threshold value (e.g., three) (i.e., only when the priority of attribute information of the object viewed or specified by the user is higher than that of other attribute information). These allow for improved accuracy of an “object combination” currently desired by the user.

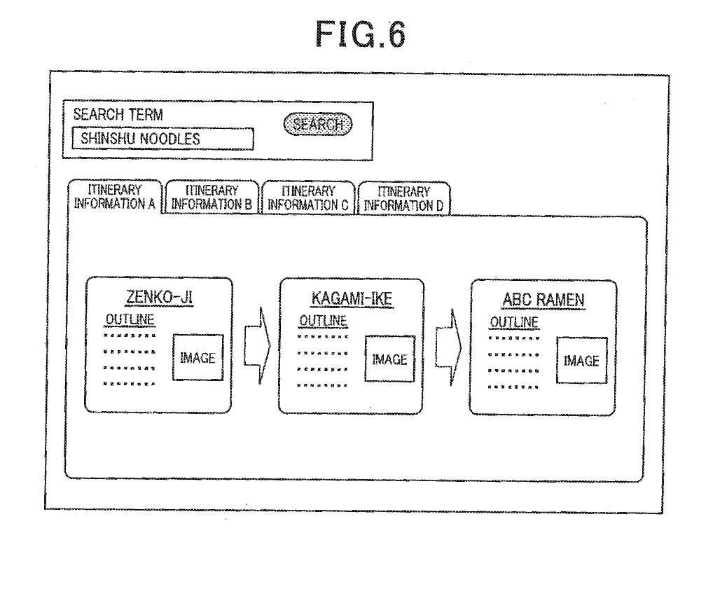

Subsequently, the combination presenter 45 of the system controller 4 sends the information indicating the “object combination” determined in Step S9 to the user terminal T1 that has made the search request or the web page request (Step S10). The information indicating the “object combination” sent to the user terminal T1 is displayed in a window screen, for example, by the web browser of the user terminal T1. The information indicating the object combination is thus presented. FIG. 6 is a diagram showing an example display screen of information indicating an object combination. The display screen shown in FIG. 6 has tabs that can switch between a plurality of pieces of itinerary information (information indicating the object combinations) displayed on the screen. The name and an image of each object that are displayed on this display screen are hyperlinked to the URL of a web page that provides detailed information about the object. The information indicating the object combinations may be embedded in a web page that displays search results sent in response to the search request by the user terminal T1 so as to be displayed or popped up. Alternatively, the information indicating the object combinations may be embedded on a web page sent in response to the page request by the user terminal T1 so as to be displayed or popped up.

Alternatively, the combination presenter 45 may send an e-mail in which the information indicating the object combinations is written to the e-mail address of the user of the user terminal T1.

As described above, according to Example 1, based on a combination of pieces of attribute information of objects identified from a user's history information, an “object combination” corresponding to attribute information of an object currently viewed or specified by the user is determined, and information indicating the object combination is presented to the user. Thus, from among the objects that the user previously viewed or specified but, for example, has forgot, an “object combination” currently desired by the user can be selected out using a superordinate concept of an object currently viewed or specified by the user. Consequently, an “object combination” currently desired by the user can be accurately recommended.

### Example 2

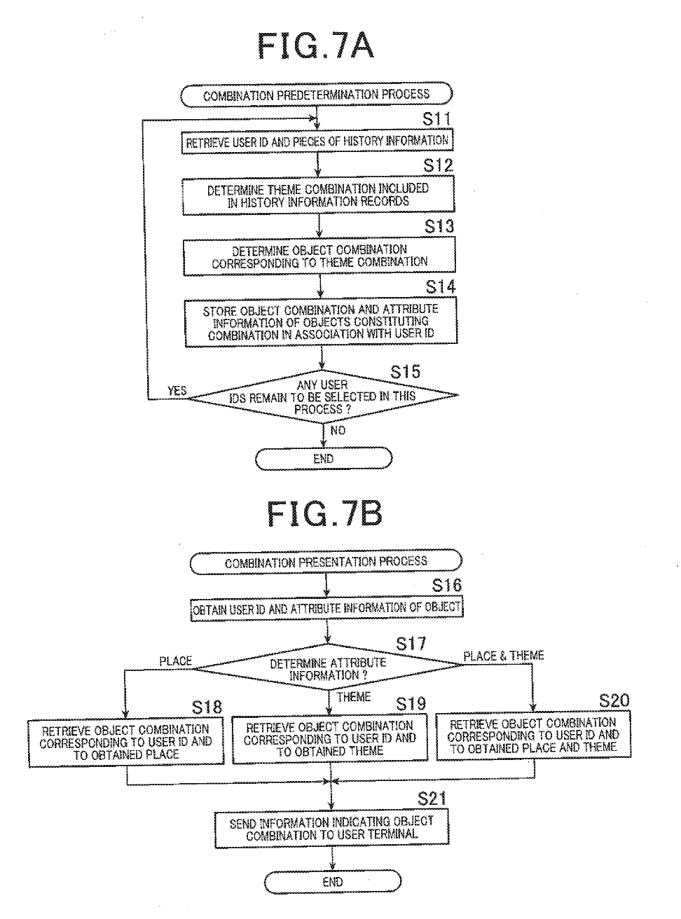

The following describes how the information providing system S according to Example 2 works, with reference to FIG. 7. Example 2 differs from Example 1 in that an “object combination” corresponding to a theme combination is predetermined and stored. FIG. 7A is a flowchart showing a combination predetermination process performed by the system controller 4 of the information providing server SA, in Example 2. This combination predetermination process is a process for predetermining an object combination and is periodically performed, for example, at predetermined intervals. FIG. 7B is a flowchart showing a combination presentation process performed by the system controller 4 of the information providing server SA, in Example 2.

When the combination predetermination process shown in FIG. 7A is started, the history information retriever 42 of the system controller 4 retrieves a user ID selected from among the plurality of user IDs stored in the history information database 22 and the pieces of history information associated with the selected user ID (Step S11). For example, when the user ID is “U00001”, the history information records with the record Nos. 1 to 14, which are associated with “U00001”, are retrieved from the history information database 22 shown in FIG. 4. In Step S11, as in Step S3, the history information retriever 42 may retrieve, among the plurality of history information records, a history information record in which the length of time used to view the object indicated by the record is greater than or equal to the threshold value. Alternatively, the history information retriever 42 may retrieve a history information record except the history information records already used to determine an object combination.

Subsequently, the combination determiner 43 of the system controller 4 determines a “theme combination” that is included in the history information records retrieved in Step S11, for example, by referring to the above-described theme combination list (Step S12). For example, when the history information records with the record Nos. 1 to 14, which are associated with “U00001”, are retrieved from the history information database 22 shown in FIG. 4, the theme combinations 1 to 8 and 10 are determined from the theme combination list shown in FIG. 2B. In Step S12, as in Step S4, based on the priorities of the themes included in the plurality of history information records retrieved in Step S11, the combination determiner 43 may determine a “theme combination” whose priorities are relatively high. The method by which the priority setter 44 sets the priorities is the same as in Example 1.

Subsequently, the combination determiner 43 of the system controller 4 determines an “object combination” corresponding to the “theme combination” determined in Step S12, from the pieces of history information retrieved in Step S11 (Step S13). The method for determining the object combination here is the same as the above Step S9, especially, the same as the method for determining an “object combination” corresponding to the “theme combination” determined in Step S6. As in Step S9, the combination determiner 43 may determine an object combination only when the number of pieces of history information of each of the plurality of themes is greater than or equal to the first threshold value and the number of such themes, whose number of the pieces of history information is greater than or equal to the first threshold value, is greater than or equal to the second threshold value. Alternatively, the combination determiner 43 may determine an object combination only when the length of time used to view the objects indicated by the pieces of history information of each of the plurality of themes is greater than or equal to the first threshold value and the number of such themes, which each have a viewing length of time greater than or equal to the first threshold value, is greater than or equal to the second threshold value.

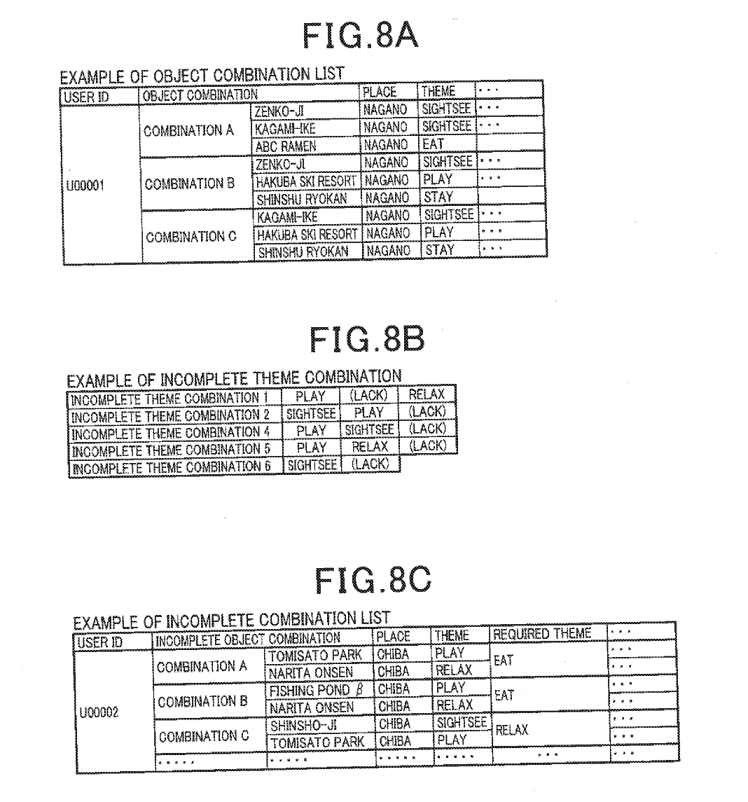

Subsequently, the combination determiner 43 of the system controller 4 stores, in a storage unit 2, the “object combination” determined in Step S13 and attribute information of the objects that constitute the combination in association with the user ID retrieved in Step S11, for example, as an object combination list (Step S14). FIG. 8A is a diagram showing an example of the object combination list. The object combination list shown in FIG. 8A stores the combination A of “Zenko-ji”, “Kagami-ike”, and “ABC Ramen”, “Nagano” and “sightsee” as attribute information of “Zenko-ji”, “Nagano” and “sightsee” as attribute information of “Kagami-ike”, and “Nagano” and “eat” as attribute information of “ABC Ramen” in association with each other.

Next, the system controller 4 determines whether any user IDs remain to be selected in this process (the combination predetermination process) (Step S15). If it is determined that any user IDs remain to be selected in this process (YES in Step S15), the process returns to Step S11. Back in Step S11, the history information retriever 42 of the system controller 4 selects a user ID yet to be selected, and performs the same process as described above. On the other hand, if it is determined that no user ID remains to be selected in this process (NO in Step S15), the combination predetermination process shown in FIG. 7A is terminated. If it is determined in Step S15 that a predetermined number of user IDs are selected in this process, the combination predetermination process shown in FIG. 7A may be terminated.

After that, as with the combination presentation process shown in FIG. 5, the combination presentation process shown in FIG. 7B is started when the system controller 4 of the information providing server SA receives a search request including a search query or a web page request, for example, from the user terminal T1.

When the combination presentation process shown in FIG. 7B is started, the attribute information obtainer 41 of the system controller 4 obtains the user ID of the user of the user terminal T1 that has sent a search request or a page request and attribute information of an object viewed or specified by the user, as in the above Step S1 (Step S16). If an “object combination” corresponding to first attribute information of the object viewed or specified by the user is determined in the previously performed combination presentation process shown in FIG. 7B and second attribute information identical to the first attribute information is obtained in Step S16 within a predetermined period of time after the determination, the system controller 4 may terminate the process without performing Step S17 and subsequent steps.

Subsequently, the system controller 4 determines whether the attribute information obtained in Step S16 is a place, a theme, or both a place and a theme (Step S17). If it is determined that the attribute information is a place (PLACE in Step S17), the process proceeds to Step S18. On the other hand, if it is determined that the attribute information is a theme (THEME in Step S17), the process proceeds to Step S19. On the other hand, if it is determined that the attribute information is both a place and a theme (PLACE & THEME in Step S17), the process proceeds to Step S20.

In Step S18, the combination determiner 43 of the system controller 4 retrieves an “object combination” corresponding to the place obtained in Step S16 (i.e., associated with the place) from the object combination list corresponding to the user ID obtained in Step S16, and the process proceeds to Step S21. On the other hand, in Step S19, the combination determiner 43 of the system controller 4 retrieves an “object combination” corresponding to the theme obtained in Step S16 (i.e., associated with the theme) from the object combination list corresponding to the user ID obtained in Step S16, and the process proceeds to Step S21.

In Step S20, the combination determiner 43 of the system controller 4 retrieves an “object combination” corresponding to the place and the theme obtained in Step S16 (i.e., associated with the place and the theme) from the object combination list corresponding to the user ID obtained in Step S16, and the process proceeds to Step S21. In Step S21, the combination presenter 45 of the system controller 4 sends information indicating the “object combination” retrieved in Step S18, S19, or S20 to the user terminal T1 that has made the search request or the web page request.

As described above, according to Example 2, by using predetermined and stored “object combinations”, an “object combination” corresponding to attribute information of an object currently viewed or specified by a user is determined, and information indicating the combination is presented to the user. Thus, in addition to the same effect as in Example 1, the load required for the information providing server SA to determine the combination when the user views or specifies the object can be reduced, and an “object combination” currently desired by the user can be more quickly recommended.

### Example 3

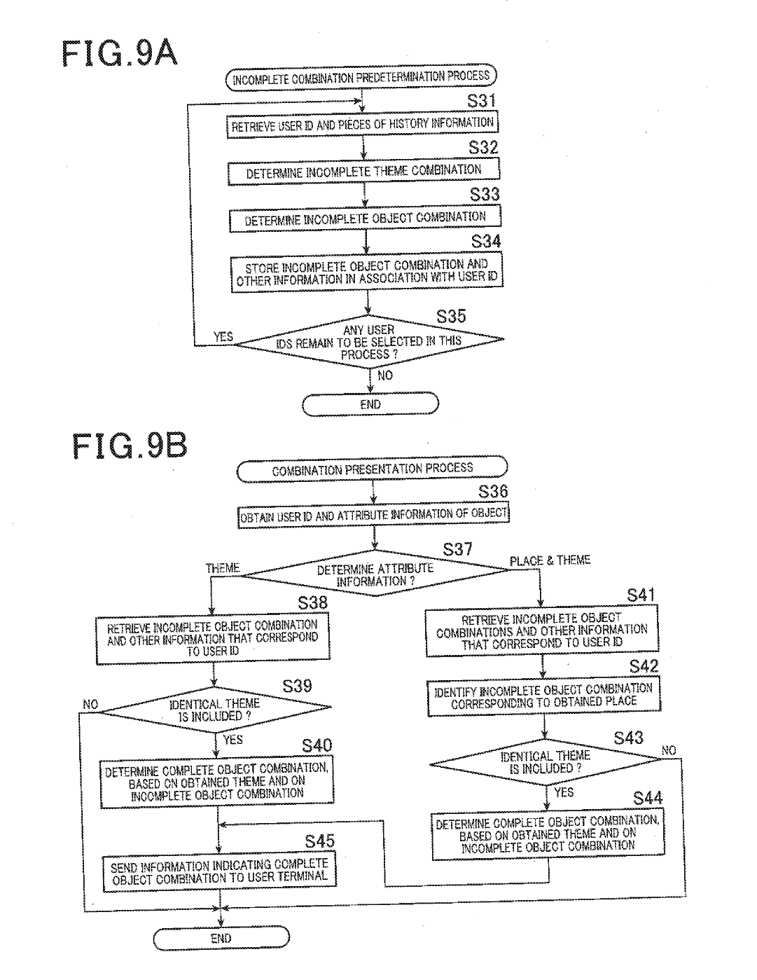

The following describes how the information providing system S according to Example 3 works, with reference to FIG. 9. Although a case where a theme combination is completed based on a user's history information is assumed in Example 2, there may be a case where no theme combination is completed depending on what a user's history information includes, that is, where there is a lack of one or more themes required to complete a theme combination. Such a “theme combination” that lacks one or more themes is referred to as an “incomplete theme combination”. An “object combination” corresponding to the “incomplete theme combination” is referred to as “incomplete object combination”. In Example 3, a complete object combination is determined using such incomplete combinations.

FIG. 9A is a flowchart showing an incomplete combination predetermination process performed by the system controller 4 of the information providing server SA, in Example 3. This incomplete combination predetermination process is a process for predetermining an incomplete object combination and is periodically performed, for example, at predetermined intervals. FIG. 9B is a flowchart showing a combination presentation process performed by the system controller 4 of the information providing server SA, in Example 3.

When the combination predetermination process shown in FIG. 9A is started, the history information retriever 42 of the system controller 4 retrieves a user ID (an example of the user ID of a predetermined user) selected from among the plurality of user IDs stored in the history information database 22 and the pieces of history information associated with the selected user ID (Step S31). For example, when the user ID is “U00002”, the history information records with the record Nos. 1 to 4, which are associated with “U00002”, are retrieved from the history information database 22 shown in FIG. 4.

Subsequently, based on the themes of objects identified from the pieces of history information retrieved in Step S31, the combination determiner 43 of the system controller 4 determines, for example, an “incomplete theme combination” that lacks one theme, for example, by referring to the above-described theme combination list (Step S32). How many themes an “incomplete theme combination” to be determined lacks is preset. An “incomplete theme combination” that lack two themes may be determined. FIG. 8B is a diagram showing an example of incomplete theme combinations. The example of FIG. 8B is an example where the history information records with the record Nos. 1 to 4, which are associated with “U00002”, are retrieved from the history information database 22 shown in FIG. 4. As shown in FIG. 8B, the incomplete theme combinations 1, 2, 4, 5, and 6 are determined based on the theme combination list shown in FIG. 2B. Although the number of themes that constitute the incomplete theme combination 6 shown in FIG. 8A is one, this combination is also an incomplete theme combination.

Subsequently, the combination determiner 43 of the system controller 4 determines an “incomplete object combination” corresponding to the “incomplete theme combination” determined in Step S32, from the pieces of history information retrieved in Step S31 (Step S33). That is, an “incomplete object combination” corresponding to the themes that constitute the incomplete theme combination is determined. The method for determining the object combination here is the same as the above Step S9, especially, the same as the method for determining an “object combination” corresponding to the “theme combination” determined in Step S6.

Next, the combination determiner 43 of the system controller 4 stores, in the storage unit 2, the “incomplete object combination” determined in Step S33, attribute information of the objects that constitute the incomplete object combination, and theme (s) required to complete a theme combination (i.e., missing theme(s)) in association with the user ID obtained in Step S31, for example, as an incomplete combination list (Step S34). The “incomplete object combination” determined in Step S33, the attribute information of the objects that constitute the incomplete object combination, and the theme (s) required to complete a theme combination are an example of “incomplete information about the incomplete combination”. FIG. 8C is a diagram showing an example of the incomplete combination list. The incomplete combination list shown in FIG. 8C stores, for example, the incomplete object combination of “Tomisato Park” and “Narita Onsen”, “Chiba” and “play” as attribute information of “Tomisato Park”, “Chiba” and “relax” as attribute information of “Narita Onsen”, and “eat” as a theme required to complete a theme combination (required theme) in association with each other. Step S35 is the same as the above Step S15.

When the combination presentation process shown in FIG. 9B is started, the attribute information obtainer 41 of the system controller 4 obtains the user ID of the user of the user terminal T1 that has sent a search request or a page request and attribute information of an object viewed or specified by the user, as in the above Step S1 (Step S36).

Subsequently, the system controller 4 determines whether the attribute information obtained in Step S36 is a theme or both a place and a theme (Step S37). If it is determined that the attribute information is a theme (THEME in Step S37), the process proceeds to Step S38. On the other hand, if it is determined that the attribute information is both a place and a theme (PLACE & THEME in Step S37), the process proceeds to Step S41.

In Step S38, the combination determiner 43 of the system controller 4 retrieves, from the incomplete combination list corresponding to the user ID obtained in Step S36, an incomplete object combination and the theme(s) required to complete the corresponding theme combination (required theme(s)). The combination determiner 43 of the system controller 4 then determines whether the theme identical to the theme obtained in Step S36 is included in the required theme(s) retrieved in Step S38 (Step S39). If a plurality of themes are required to complete the theme combination, the theme identical to each of the plurality of themes needs to have been obtained in Step S36. If it is determined that the identical theme is included in them (YES in S39), the process proceeds to Step S40. If it is determined that no identical theme is included in them (NO in Step S39), the combination presentation process shown in FIG. 9B is terminated.

In Step S40, the combination determiner 43 of the system controller 4 determines a complete object combination, based on the theme obtained in Step S36 and on the “incomplete object combination” retrieved in Step S38, and the process proceeds to Step S45. For example, the combination determiner 43 determines the complete combination from both an object corresponding to the theme obtained in Step S36 and the objects that constitutes the incomplete object combination. The object corresponding to the theme obtained in Step S36 is identified from the received search query, for example, based on the association lists, or is identified from the web page relating to the received page request.

On the other hand, in Step S41, the combination determiner 43 of the system controller 4 retrieves, from the incomplete combination list corresponding to the user ID obtained in Step S36, each incomplete object combination, attribute information of the objects that constitute the incomplete object combination, and the theme(s) required to complete the corresponding theme combination (required theme(s)). Based on the pieces of attribute information retrieved in Step S41, the combination determiner 43 of the system controller 4 identifies an “incomplete object combination” corresponding to the place obtained in Step S36, from among the “incomplete object combinations” retrieved in Step S41 (Step S42). For example, an “incomplete object combination” in which the pieces of attribute information of all the objects include the place obtained in Step S36 is identified. For example, when the place obtained in Step S36 is “Chiba”, the incomplete object combination of “Tomisato Park” and “Narita Onsen” shown in FIG. 8C is identified in Step S42 because the place corresponding to “Tomisato Park” is “Chiba” and the place corresponding to “Narita Onsen” is also “Chiba”.

Subsequently, the combination determiner 43 of the system controller 4 determines whether the theme identical to the theme obtained in Step S36 is included in the required theme(s) retrieved in Step S41 (Step S43). This determination is the same as that in Step S39. If it is determined that the identical theme is included in them (YES in S43), the process proceeds to Step S44. On the other hand, if it is determined that no identical theme is included in them (NO in Step S43), the combination presentation process shown in FIG. 9B is terminated.

In Step S44, as in Step S40, the combination determiner 43 of the system controller 4 determines a complete object combination, based on the theme obtained in Step S36 and on the “incomplete object combination” identified in Step S42, and the process proceeds to Step S45. In Step S45, the combination presenter 45 of the system controller 4 sends information indicating the “complete object combination” determined in Step S40 or S44 to the user terminal T1 that has made the search request or the web page request.

As described above, according to Example 3, even if no theme combination is completed depending on what a user's history information includes, the load required for the information providing server SA to determine a combination when the user views or specifies an object can be reduced, and an “object combination” currently desired by the user can be more quickly recommended.

Although, for example, tourist sites and facilities are taken as examples of objects viewed or specified by users in the above-described embodiment, the above objects may be items (e.g., hats, accessories, clothes, shoes, and glasses). In this case, item combinations (e.g., fashion combinations) can be presented as object combinations to users.

### REFERENCE SIGNS LIST

1 communication unit
2 storage unit
3 input/output interface unit
4 system controller
5 system bus
Tn user terminal
SA information providing server
NW network

1. An information processing device comprising:
at least one memory configured to store computer program code;
at least one processor configured to access said at least one memory, read said computer program code, and operate as instructed by said computer program code, said computer program code including:
receiving code configured to cause at least one of said at least one processor to receive a request transmitted from a user terminal through a network;
first obtaining code configured to cause at least one of said at least one processor to obtain attribute information of a first object viewed or specified by a user of the user terminal which has transmitted the request, and identification information of the user;
second obtaining code configured to cause at least one of said at least one processor to retrieve, from a history information database that stores history information including information about a second object previously viewed or specified by each of the plurality of users in association with identification information of each of the users, the history information corresponding to the identification information of the user of the user terminal;
first determining code configured to cause at least one of said at least one processor to determine a second object combination, based on attribute information of the second object identified from the history information retrieved by the second obtaining code, the second object combination being a combination of the second objects corresponding to the attribute information of the first object obtained by the first obtaining code; and
transmitting code configured to cause at least one of said at least one processor to transmit information indicating the second object combination determined by the first determining code to the user terminal through the network.

2. The information processing device according to claim 1, wherein based on priorities of a plurality of pieces of the attribute information, the first determining code causes at least one of said at least one processor to determine the second object combination corresponding to a combination of pieces of attribute information whose priorities are relatively high.

3. The information processing device according to claim 2, further comprising setting code configured to cause at least one of said at least one processor to set the priority higher for the attribute information having a larger number of pieces of history information, among a plurality of pieces of the attribute information.

4. The information processing device according to claim 3, wherein the setting code causes at least one of said at least one processor to set the priority higher for the attribute information having a larger number of the pieces of history information and having a shorter elapsed time since the pieces of history information were stored in the history information database.

5. The information processing device according to claim 2, further comprising setting code configured to cause at least one of said at least one processor to set the priority higher for the attribute information having a longer length of time used to view second objects indicated by pieces of history information thereof, among a plurality of pieces of the attribute information.

6. The information processing device according to claim 5, wherein the setting code causes at least one of said at least one processor to set the priority higher for the attribute information having a longer length of time used to view the second objects indicated by the pieces of history information and having a shorter elapsed time since the pieces of history information were stored in the history information database.

7. The information processing device according to claim 1, wherein the second obtaining code causes at least one of said at least one processor to retrieve the history information in which a length of time used to view a second object indicated thereby is greater than or equal to a threshold value, from among a plurality of pieces of the history information.

8. The information processing device according to claim 1, wherein the second obtaining code causes at least one of said at least one processor to retrieve the history information except the history information already used to determine the second object combination.

9. The information processing device according to claim 1, wherein the first determining code is configured to cause at least one of said at least one processor to determine the second object combination only when the number of pieces of history information of each of a plurality of pieces of the attribute information is greater than or equal to a first threshold value and the number of the pieces of attribute information, whose number of the pieces of history information is greater than or equal to a first threshold value, is greater than or equal to a second threshold value.

10. The information processing device according to claim 1, wherein the first determining code is configured to cause at least one of said at least one processor to determine the second object combination only when a length of time used to view second objects indicated by pieces of history information of each of a plurality of pieces of the attribute information is greater than or equal to a first threshold value and the number of the pieces of attribute information, which each have a viewing length of time greater than or equal to a first threshold value, is greater than or equal to a second threshold value.

11. The information processing device according to claim 1, wherein the first determining code is configured to cause at least one of said at least one processor to determine the second object combination only when a priority of the attribute information is greater than or equal to a third threshold value.

12. The information processing device according to claim 1, further comprising:
third obtaining code configured to cause at least one of said at least one processor to retrieve, from the history information storage database, the history information corresponding to a predetermined user identification information; and
second determining code configured to cause at least one of said at least one processor to determine an incomplete combination of pieces of attribute information, based on attribute information of the second object identified from the history information retrieved by the third obtaining code, the incomplete combination lacking one or more pieces of attribute information, wherein
the history information database stores incomplete information about the incomplete combination determined by the second determining code in association with the user identification information,
the second obtaining means retrieves, from the history information database, the incomplete information corresponding to the identification information obtained by the first obtaining code, and
the first determining code is configured to cause at least one of said at least one processor to determine the second object combination, based on the attribute information obtained by the first obtaining code and on the incomplete information retrieved by the second obtaining code.

13. The information processing device according to claim 1, wherein if, within a predetermined period of time after the second object combination corresponding to the first attribute information is determined, the second attribute information identical to the first attribute information is obtained, the determining code does not determine the second object combination corresponding to the second attribute information.

14. An information processing method performed by a computer, the method comprising:
receiving a request transmitted from a user terminal through a network;
obtaining attribute information of a first object viewed or specified by a user of the use terminal which has transmitted the request, and identification information of the user;
retrieving, from a history information database for storing history information including information about a second object previously viewed or specified by each of the plurality of the users in association with identification information of each of the users, the history information corresponding to the obtained identification information of the user of the user terminal;
determining a second object combination, based on attribute information of the second object identified from the retrieved history information, the second object combination being a combination of the second objects corresponding to the obtained attribute information of the first object; and
transmitting information indicating the determined second object combination to the user terminal through the network.

15. A non-transitory recording medium recording an information processing program for causing a computer to:
receive a request transmitted from a user terminal through a network;
obtain attribute information of a first object viewed or specified by a user of the user terminal which has transmitted the request, and identification information of the user;
retrieve, from a history information database for storing history information including information about a second object previously viewed or specified by each of a plurality of users in association with identification information of each of the users, the history information corresponding to the identification information of the user of the user terminal;
determine a second object combination, based on attribute information of the second object identified from the history information retrieved, the second object combination being a combination of the second objects corresponding to the attribute information of the first object obtained; and
transmit information indicating the second object combination determined, to the user terminal through the network.
